(19) United States
(12) Patent Application Publication
(10) Pub. No.: US 2010/0078118 A1
(43) Pub. Date: Apr. 1, 2010

(54) REPAIR AND STRENGTHENING OF SMALL DIAMETER PIPES WITH FRP LAMINATES

(76) Inventor: Mohammad R. Ehsani, Tucson, AZ (US)

Correspondence Address: QUICKPATENTS, INC., 32861 CALLE PERFECTO, SUITE A, SAN JUAN CAPISTRANO, CA, 92675, US

(21) Appl. No.: 12/579,229

(22) Filed: Oct. 14, 2009

Related U.S. Application Data
(63) Continuation-in-part of application No. 12/233,849, filed on Sep. 19, 2008.
(60) Provisional application No. 61/270,013, filed on Jul. 2, 2009.
(60) Provisional application No. 61/207,849, filed on Feb. 18, 2009.

(51) Int. Cl. B32B 43/00

(52) U.S. Cl. 156/94

(57) ABSTRACT

A method is disclosed for repairing or strengthening a damaged portion of a pipe. A patch of required dimensions is prepared from a composite laminate having a fabric layer with a plurality of fibers embedded into a cured resin. The pipe is then prepared to receive the patch and the epoxy resin is applied to an outside surface of the patch. The patch is then coiled and secured around a mandrel and transported thereby to the damaged portion of the pipe through an open end thereof, such that during transport through the pipe the patch does not contact the inside surface of the pipe. A bladder inside the coiled patch is pressurized to force the unrolling of the patch to contact the inside surface of the patch. The pressure is maintained against the patch until the epoxy resin is substantially cured, whereupon the bladder is deflated and removed with the mandrel from the pipe. A method of repairing such a pipe while fluid flows therethrough, and a method of repairing a corrugated steel pipe, is also disclosed.

### CROSS-REFERENCE TO RELATED APPLICATIONS

This application is a continuation-in-part of U.S. application Ser. No. 12/233,849, filed on Sep. 19, 2008, and claims the benefit of U.S. Provisional Patent Application 61/270,013, filed on Jul. 14, 2009, and U.S. Provisional Patent Application 61/205,906, filed on Feb. 6, 2009, and U.S. Provisional Patent Application 61/207,849, filed on Feb. 18, 2009, all incorporated herein by reference.

### STATEMENT REGARDING FEDERALLY SPONSORED RESEARCH AND DEVELOPMENT

Not Applicable.

### FIELD OF THE INVENTION

This invention relates to pipelines, and more particularly to improved pipeline reinforcement devices and methods.

### DISCUSSION OF RELATED ART

A large number of pipelines and culverts worldwide have aged and are failing as a result. Studies by the American Society of Civil Engineers, among others, have highlighted the loss of revenue and resources caused by deteriorating pipes nationwide. In some case, steel pipes and culverts are badly corroded and fluid either leaks into or out of the pipe. In other cases, concrete pipes are damaged and broken into pieces as a result of extensive cracking; fluid can easily escape or enter these pipes through these cracked joints. Yet, in other cases the joints leak where the sections of the pipe are connected together.

There are many methods for lining a pipe with a water-tight layer to prevent the leakage of fluids, such as when such pipes need to be repaired, strengthened, or refurbished. One such method is disclosed in U.S. Pat. No. 7,270,150 by Warren on Sep. 18, 2007. Another method is disclosed in U.S. Pat. No. RE35944 by Driver, et al. on Nov. 3, 1998. These methods utilize internal pressure from air or a liquid to expand a liner inside of the pipe in a way that the liner will adhere to the inside surface of a pipe. However, the liners that are specified, e.g. felt, are only intended to be resin-absorbing media, such that the liners absorb relatively large quantities of resins. There is no mention of strengthening a pipe in any of these patents, nor will the mixture of felt and resin provide any substantial strength to the pipe.

Another prior art method, taught in U.S. Pat. No. 5,931,198 to Raji and Fyfe., describes the strengthening of pipes with carbon fabric saturated with resin. In such a method, workers transport fibrous layers into the pipe, affix them to the inside of the pipe, and then soak the layers with resin that eventually cures to form the reinforcement. Alternately, “pre-formed” sections are soaked with resin and transported into the pipe. Such a method requires multiple pieces of “pre-formed” sections to be spliced together at the seams within the pipe using lap splice pieces of fabric impregnated with resin. Further, such pre-formed sections must be small enough to fit within a small pipe opening, such as a manhole, but it is not clear how this is to be accomplished in the—198 patent with relatively long strips of composite reinforcement material, particularly with cured “pre-formed” sections. As such, the “pre-formed” sections must necessarily be relatively short. In fact, recently Fibrwrap Construction, an affiliate of Fyfe was granted a contract (Project #070637.1) by Sky Engineering (Phoenix, Ariz.) to retrofit two large-diameter pipes in Tristate Power Generation Plant (Craig, Colo.). The design provided by the consulting firm of SGH (Waltham, Mass.) required application of two layers of carbon fabric to the inside surface of the pipes and the project was carried out in March and April 2008. In spite of extreme cold temperatures (−6 degrees Fahrenheit) and the time constraints imposed by the plant, Fibrwrap Construction saturated the carbon fabrics outside of the pipe and carried the fabric into the pipe, applying the wet fabric one layer at a time and waiting for it to cure in place. As discussed herein, the current invention offers significant advantages over Raji and Fyfe. Clearly the “pre-formed” sections of Fyfe have significant drawbacks and are not fully pre-formed as with the present invention.

Other pipe reinforcement methods are disclosed in Fawley's patents: U.S. Pat. No. 5,683,530 on Nov. 4, 1997; U.S. Pat. No. 5,677,046 on Oct. 14, 1997; U.S. Pat. No. 4,559,974 on Dec. 24, 1985; and U.S. Pat. No. 5,632,307 on May 27, 1997. Such methods contemplate utilizing composite reinforcing strips on the outside surface of the pipe, however, and make no provision for use inside a pipe or vessel.

My previous U.S. patent application Ser. No. 12/233,849, filed on Sep. 19, 2008, teaches an improved method of repairing and reinforcing pipes that are large enough for workers to enter the pipe and make the taught repairs. However, such a method is difficult to practice in pipes too small to admit workers.

Therefore, there is a need for a method that facilitates the strengthening and repair of relatively small pipes from the inside. Such a needed method would result in a reinforcement of the pipe that is substantially water-tight along its length, strong, light-weight, relatively easy-to-install, and that can be installed quickly, reducing down-time of the pipe. The composite reinforcement material of the needed method would be easy to fabricate, even when necessitating customization, easy to transport and handle, light-weight, and easy-to-place within the pipe. The present invention accomplishes these objectives.

### SUMMARY OF THE INVENTION

The present invention is a method for repairing a damaged portion of a pipe. Such damage could be due, for example, to cracking of concrete or movement of joints. Additionally, the present invention can strengthen a pipe so that it can resist higher pressures and loads. Examples of strengthening applications include a steel pipe whose wall thickness may have been reduced due to corrosion or a concrete pipe where corrosion of the reinforcing steel has resulted in loss of strength in the pipe. The pipe can be made of any material such as steel, cast iron, corrugated metal, PVC, brick, clay, fiberglass, cast-in-place or pre-cast concrete, pre-stressed concrete cylinder pipe, and the like.

In a first embodiment of the method, the size of a patch required to repair the damaged portion of the pipe is determined. Next, the patch is prepared from an FRP or composite laminate of the required dimensions. The composite laminate has a fabric layer with a plurality of fibers embedded into a cured resin matrix.

The pipe and specifically the damaged portion thereof is then prepared to receive the patch, such as by cleaning and application of a tack coat of epoxy resin, or the like. The epoxy resin is applied to an outside surface of the patch. The patch is then coiled and secured around a mandrel, or the like, and transported thereby to the damaged portion of the pipe through an open end thereof, such that during transport through the pipe the patch does not contact the inside surface of the pipe.

Once the patch is positioned properly to fully cover the damaged area of the pipe, in one embodiment, a bladder inside the coiled patch is pressurized to force the unrolling of the patch from the mandrel. Such a pressurized bladder forces pressurized contact of the outside surface of the patch against the damaged portion of the pipe. The pressure within the bladder may be applied to the patch until the epoxy resin is substantially cured, whereupon the bladder is deflated and removed with the mandrel from the pipe. Such a patch operation can be repeated by applying multiple overlapping patches along the length of pipe to piece together what is essentially a longer fabricated pipe inside the original pipe. Patch overlaps are in the direction of flow to reduce the chance of the liquid flowing within the pipe of leaking between adjacent patches. Each edge of the patch may then be sealed against the inside surface of the pipe with a circular clamp, as desired.

In one embodiment, the damaged portion of the pipe may be strengthened and repaired even as fluid flows therethrough. This eliminates the need for bypassing the pipe on the street level and the accompanying traffic control costs and difficulties that may result. In such an embodiment, an upstream seal is placed upstream of the damaged portion of the pipe, and a downstream seal is placed downstream of the damaged portion of the pipe. A conduit is provided between each seal, the conduit being smaller than the pipe, such that the fluid can flow between the seals.

In such an embodiment, the patch is prepared by coiling the patch around the conduit, typically by workers in manholes adjacent to the damaged portion of the pipe. The coiled patch is moved to the damaged portion of the pipe, typically with the moveable mandrel, such that the patch does not contact the inside surface of the pipe. The patch is uncoiled and forced against the inside surface of the damaged portion of the pipe, such as with the mandrel modified to receive the conduit therethrough. Once the resin is cured, pressure against the patch is released. Additional patches may be applied based on the size of the damaged portion of the pipe. Optionally, an outer edge of the outermost patches may be sealed against the inside surface of the pipe with a circular clamp. The seals and the conduit are then removed from the pie to allow the fluid to flow through the patched portion of the pipe.

In an alternate embodiment of the invention, the patch is coiled around a longitudinal axis that is the aligned with the longitudinal axis of the pipe at the open end of the pipe. The patch is inserted into the open end of the pipe, and the coiled patch is released such that the outside surface of the patch presses against the inside surface of the pipe. In such an embodiment, the bladder may be inserted into the pipe and inflated to press the patch firmly against the inside surface of the pipe until the epoxy resin is cured. In some cases, depending on the diameter of the pipe and the stiffness of the patch, an elastic memory of the patch that has been forced into a coiled position can cause the patch to snap open when released, thereby allowing the patch to press against and bond to the surface of the pipe without requiring a bladder.

In an embodiment wherein the pipe is a corrugated steel pipe, the FRP laminate patch comprises a layer of non-carbon fiber adjacent the outside surface of the patch, and a carbon-fiber layer between the non-carbon fiber layer and the inside surface of the patch. As such, after the patch is inserted into the pipe, spaces between the corrugated steel pipe and the patch proximate each end of the patch are filled with a filler material to seal the pipe between the corrugated steel and the patch.

The present method facilitates the strengthening and repair of relatively small pipes from the inside and results in a reinforcement of the pipe that is substantially water-tight along its length, strong, light-weight, relatively easy-to-install, and that is installed quickly, reducing down-time of the pipe. The composite laminate material of the present method is easy to fabricate, even when customization is required. Further, the composite laminate of the present method is easy to transport and handle, light-weight, and easy-to-place within the pipe. The present invention further provides a safe barrier within a pipe or vessel that has a contaminating substance therein, such as lead paint for example. A method of repairing corrugated steel pipe is also achieved. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a cross-sectional view of a damaged portion of a pipe and a patch of the invention;

FIG. 2 is a cross-sectional view thereof, further illustrating a mandrel for delivering the patch to the damaged portion of the pipe;

FIG. 3 is a cross-sectional view thereof, further illustrating a repair of the damaged area of the pipe between two seals of the invention;

FIG. 4 is a cross-sectional view of an embodiment of the method for repairing a portion of a corrugated pipe;

FIG. 5 is an enlarged cross-sectional view thereof, taken generally along line 5-5 of FIG. 4; and

FIG. 6 is a cross-sectional view of a pipe showing multiple patches of the invention applied thereto.

### DETAILED DESCRIPTION OF THE PREFERRED EMBODIMENT

Illustrative embodiments of the apparatus and method of reinforcing a conduit or vessel are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. Moreover, herein the words “repair” and “strengthen” may be used interchangeably, as with the words “damaged” and “weakened.” For example, when a damaged section of pipe is to be repaired with the instant method, the same method may be used to strengthen a weakened section of pipe.

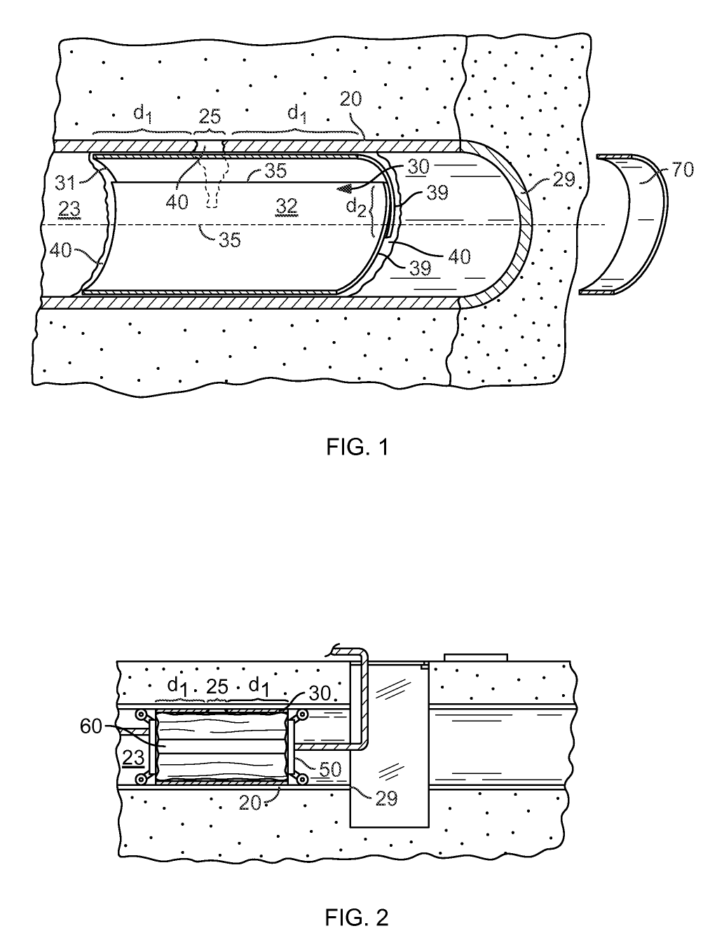

The present invention is a method for repairing a damaged portion 25 of a pipe 20 (FIGS. 1 and 2). In a first embodiment of the method, the size of a patch 30 required to repair the damaged portion 25 of the pipe 20 is determined, such as with a closed circuit CCTV camera on an elongated cable (not shown), or the like. Typically the patch 35 overlaps the non-damaged portion of the pipe 20 such that both upstream edge 31 and downstream edge 39 of the patch 30 extend past the damaged portion of the pipe by a distance d₁, such as six inches, and such that overlapping edges 35 of the patch 30 overlap each other by at least a distance d₂, such as between two and twelve inches.

Next, the patch 30 is prepared from an FRP or composite laminate 220 of the required dimensions, as detailed in my previous U.S. patent application Ser. No. 12/233,849, filed on Sep. 19, 2008. The composite laminate 220 has a fabric layer 230 with a plurality of fibers 235 embedded into a cured resin matrix 40. Such resin 40 may include epoxy, polyester, urethane, a combination thereof, or the like. Such resin 40 may also be selected based on the intended application in the field; for example, a non-toxic resin may be used for applications involving potable water pipes 20, or a chemical resistant resin may be selected when chemicals are present, such is in sewer pipes or pipes 20 containing petroleum or other chemicals. Moreover, a resin 40 may be selected that acts as a barrier to contaminants within the pipe 20, such as lead paint, asbestos, or the like. The fibers 235 saturated with the resin may pass through rollers or a press (not shown) and may be is subjected to heat to harden and cure the laminate 220. Once cured, the composite laminate 220 has an outside surface 38, and inside surface 32, and edges 35. The edges 35 may be trimmed after curing to reduce sharp and irregular areas.

Throughout this specification the term “laminate” refers to any pre-cured and pre-fabricated FRP sheet products constructed in accordance to patent applications incorporated herein, and includes such fibers as glass, carbon, aramid, or the like, embedded in a resin matrix such as polyester, vinyl ester, epoxy, or the like. Such a laminate is relatively strong, having a tensile strength of at least 60,000 psi. Such a laminate is produced in a sheet that has a width ranging from typically 4 to 60 inches, a length of typically a few hundred feet, and a thickness of typically 0.015 to 0.05 inches, making it flexible enough to be coiled for storage and transportation into pipelines from small-diameter access ports, such as manholes. Exemplary laminates of this type are currently being sold by QuakeWrap, Inc. under the trade name PipeMedic™ (www.PipeMedic.com). One of the primary advantages of such laminates is that in spite of their high tensile strength, they can be easily cut into smaller size sheets in the field. For example, one can easily cut a section of two feet long by two feet wide from a larger roll of such laminate, such as can be used on a small repair job, for example.

The pipe 20 and specifically the damaged portion 25 thereof is then prepared to receive the patch 30, such as by cleaning and application of a tack coat of epoxy resin 40, or the like, perhaps by spraying resin 40 or applying with a brush or other method. Damaged crevices, holes, cracks, and the like may also be filled with the epoxy resin 40, leak-stopping plugs or compounds, or other filler material. Alternately, the damaged portion 25 of the pipe 20 may be prepared to receive the patch 30 either before or concurrently with the preparation of the patch 30.

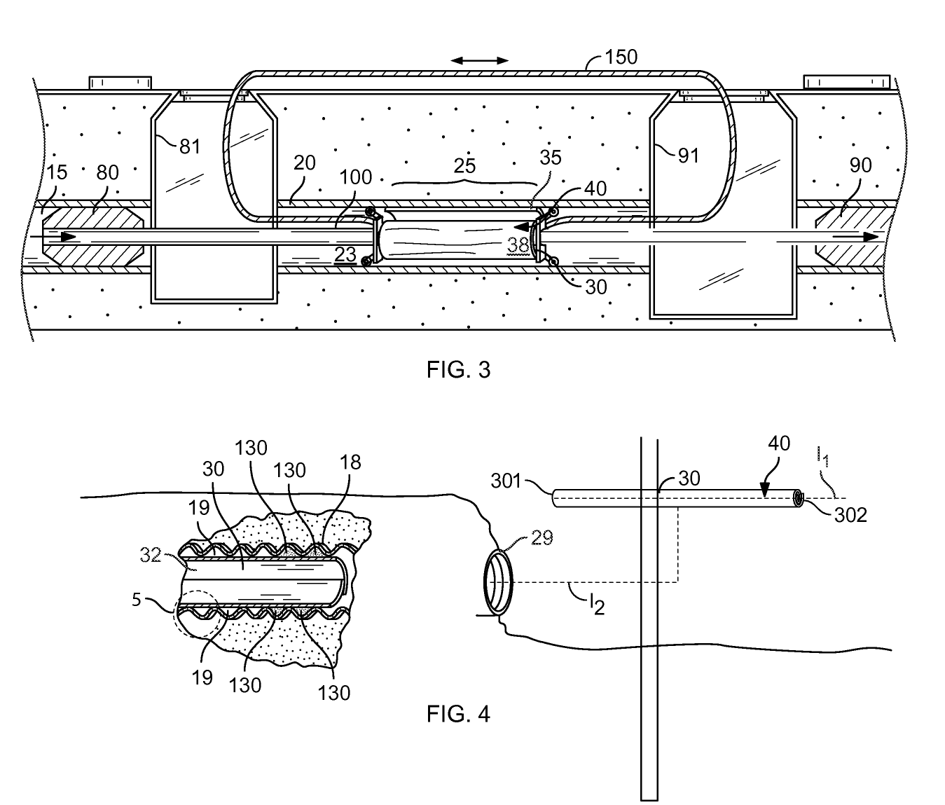

The epoxy resin 40 is applied to an outside surface 38 of the patch 30. The patch 30 is then coiled and secured around a mandrel 50 and transported thereby to the damaged portion 25 of the pipe 20 through an open end 29 thereof (FIGS. 1 and 2), such that during transport through the pipe 20 the patch 30 does not contact the inside surface 23 of the pipe 20. The coiled patch 30 may be secured with twine, plastic straps, or the like (not shown), to keep it coiled during transport. The mandrel 50 may be moved manually with a rope 150, for example, in either direction (FIG. 3) along the pipe 20, by pulling towards either an upstream manhole 81 or a downstream manhole 91. The rope 150 may also be looped around the mandrel 50 such that the mandrel 50 may be pulled in either an upstream or downstream direction by pulling the rope 150 in an opposite direction at the street-level surface.

Once the patch 30 is positioned properly to fully cover the damaged area 25 of the pipe 20, in one embodiment, a bladder 60 inside the coiled patch 30 is pressurized to force the breaking of the twine or straps and the subsequent unrolling of the patch 30 from the mandrel 50. Such a pressurized bladder 60 forces pressurized contact of the outside surface 38 of the patch against the damaged portion 25 of the pipe 20. The pressure within the bladder 60 may be applied to the patch 30 until the epoxy resin 40 is substantially cured. Alternately, the straps or twine may be released manually to allow the patch 30 to unroll.

If the length of the damaged portion 25 of the pipe 20 is larger than the patch 30, or when a relatively long portion of the pipe 20 is to be strengthened, this operation may be repeated by applying additional patches 30 to the pipe 20 (FIG. 6). Such patches 30 mutually overlap along the length of the pipe 20 and are bonded by the resin 40 to previously installed patch 30, creating what is essentially a pieced-together solid pipe 26, when cured, within the original pipe 20. Such overlaps 140 step down in the direction of liquid flow to reduce the chance of liquid leaking between adjacent patches 30. The bladder 60 is then deflated and removed with the mandrel 50 from the pipe 20. In such an embodiment, the upstream and downstream edges 31,39 of the first and last patch 30, respectively, may then be sealed against the inside surface 23 of the pipe 20 with a circular clamp 70, as desired. Such overlaps 140 are preferably a distance d₃ of between two and twelve inches wide. As such, any particular patch 30 may overlap itself by the distance d₂ and its next adjacent patch 30 by the distance d₃.

In one embodiment, the damaged portion 25 of the pipe 20 may be repaired even as fluid 15 flows therethrough (FIG. 3). In such an embodiment, an upstream seal 80 is placed upstream of the damaged portion 25 of the pipe 20, and a downstream seal 90 is placed downstream of the damaged portion 25 of the pipe 20. A conduit 100 is provided between each seal 80,90, the conduit 100 being smaller than the pipe 20, such that the fluid 15 can flow between the seals 80,90. In such an embodiment, the patch 30 is prepared by coiling the patch 30 around the conduit 100 and then moving the coiled patch 30 to the damaged portion 25 of the pipe 20 such that the patch 30 does not contact the inside surface 23 of the pipe 20. The mandrel 50 may be used for this purpose if modified to allow the conduit 100 to traverse therethrough (FIG. 3). The patch 30 is uncoiled and forced against the inside surface 23 of the damaged portion 25 of the pipe 20, such as with the bladder 60 of the modified mandrel 50. Once the resin 40 is cured, pressure against the patch 30 is released and, optionally, at least an upstream edge 301 (FIG. 4) of the patch 30 is sealed against the inside surface 23 of the pipe 20 with a circular clamp 70. The seals 80,90 and the conduit 100 are then removed from the pie 20 to allow the fluid 15 to flow through the patched portion of the pipe 20.

Alternately, the fluid may be pumped out of an upstream access point, such as the upstream manhole 81, and then into the pipe 20 through a downstream access point, such as the downstream manhole 91 (not shown). In such an embodiment, typically used where traffic at the street level is not interrupted or other expensive steps are required, the upstream seal 80 and the downstream seal 90 completely occlude the pipe 20.

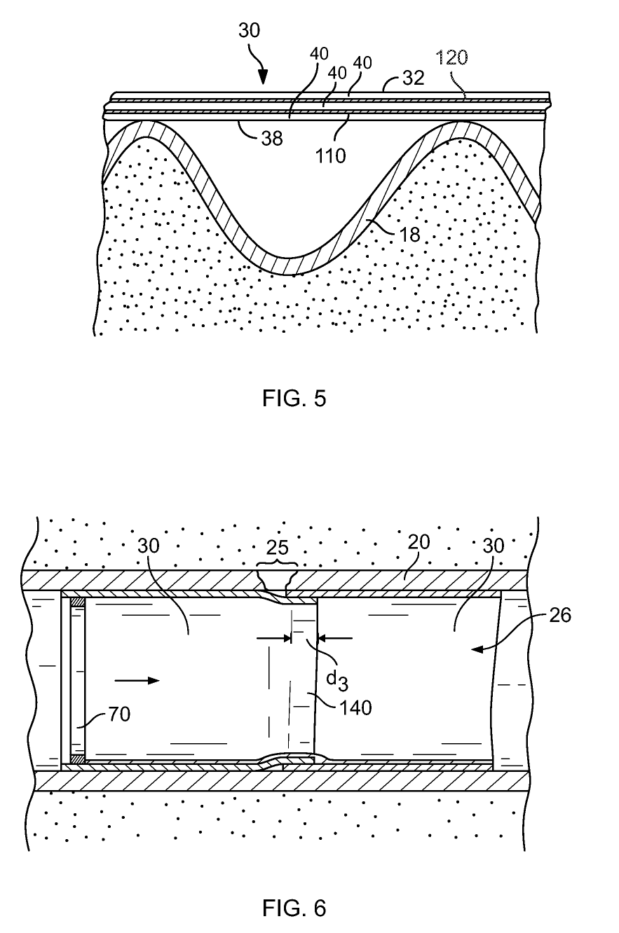

In an alternate embodiment of the invention, the patch 30 is coiled around a longitudinal axis l₁ that is the aligned with the longitudinal axis l₂ of the pipe 20 at the open end 29 of the pipe 20 (FIGS. 4 and 5). The patch is inserted into the open end 29 of the pipe 20, and the coiled patch 30 is released such that the outside surface 38 of the patch 30 presses against the inside surface 23 of the pipe 20. In such an embodiment, the bladder 60 may be inserted into the pipe 20 and inflated to press the patch 30 firmly against the inside surface 23 of the pipe 20 until the epoxy resin 40 is cured. In some cases, depending on the diameter of the pipe 20 and the stiffness of the patch 30, an elastic memory of the patch 30 that has been forced into a coiled position can cause the patch 30 to snap open when released, thereby allowing the patch 30 to press against and bond to the inside surface 23 of the pipe 20 without requiring a bladder 60. If the length of the damaged portion 25 of the pipe 20 is larger than the patch 30, or when a relatively long portion of the pipe 20 is to be strengthened, this operation may be repeated by applying additional patches 30 to the pipe 20, as previously explained.

In an embodiment wherein the pipe 20 is a corrugated steel pipe 18, the FRP laminate patch 30 may comprise a layer 110 of non-carbon fiber adjacent the outside surface 38 of the patch 30, and a carbon-fiber layer 120 between the non-carbon fiber layer 110 and the inside surface 32 of the patch 30 (FIGS. 4 and 5). Alternately, the entire laminate patch 30 may be made from a non-carbon fabric, such as glass, Kevlar, or the like.

As such, after the patch 30 is inserted into the pipe 18, spaces 19 between the corrugated steel pipe 18 and the patch 30 proximate each end 301, 302 of the patch 30 are filled with a filler material 130 to seal the pipe 20 between the corrugated steel and the patch 30. Such a filler material 130 may be the epoxy resin 40, grout, or other suitably water-tight materials. The spaces 19 between each end 301, 302 of the patch 30 are not necessarily filled with the filler material 130, since the patch 30 is waterproof. Sealing of the spaces 19 proximate each end 301,302, to prevent fluid from flowing between the corrugated pipe 18 and the patch 30, may be additionally enhanced with the circular clamps 70 if desired. As such, fluid flow through such a corrugated pipe 18 is less turbulent since the inside surfaces 38 of the one or more patches 30 are smooth in comparison to the corrugated steel walls of the corrugated pipe 18.

In one embodiment, the resin 40 may be applied again to the inside surface 32 of each patch 30 after the initial installation thereof, providing seamless joints between adjacent patches 30 and providing increased abrasion resistance to suspended abrasive materials that may flow through the pipe 20.

While a particular form of the invention has been illustrated and described, it will be apparent that various modifications can be made without departing from the spirit and scope of the invention. For example, the overlap distances d₁, d₂ and d₃ may be altered from those values previously suggested, based on the needs of the application. Accordingly, it is not intended that the invention be limited, except as by the appended claims.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the system may vary considerably in its implementation details, while still being encompassed by the invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

In general, the terms used in the following claims should not be construed to limit the is invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A method for repairing a damaged portion of a pipe, comprising the steps of:
a) determining the size of a patch required to repair the damaged portion of the pipe;
b) preparing an FRP laminate patch of the required dimensions;
c) preparing the damaged portion of the pipe to receive the patch;
d) applying an epoxy resin to an outside surface of the patch;
e) coiling and securing the patch around a mandrel adapted to transport the patch to the damaged portion of the pipe through an open end thereof, such that the patch does not contact the inside surface of the pipe;
f) inserting and rolling the mandrel and patch through the pipe to the damaged portion thereof; and
g) applying liquid pressure to a bladder inside the coiled patch to force the unrolling of the patch from the mandrel and pressurized contact of the outside surface of the patch against the damaged portion of the pipe.

2. The method of claim 1 wherein steps b) and c) are reversed.

3. The method of claim 1 further including the steps:
h) waiting for the epoxy resin to cure;
i) deflating the bladder and removing the mandrel from the pipe;
j) sealing at least an upstream edge of the patch against the inside surface of the pipe with a circular clamp.

4. The method of claim 1 wherein step a) is determining the size of a patch required to repair the damaged portion of the pipe such that both upstream and downstream edges of the patch extend past the damaged portion of the pipe by at least six inches, and such that overlapping edges of the patch overlap each other by at least two inches.

5. A method for repairing a damaged portion of a pipe through which a fluid is flowing, comprising the steps of:
a) placing an upstream seal upstream of the damaged portion of the pipe and placing a downstream seal downstream of the damaged portion of the pipe, while providing a conduit therebetween having a smaller diameter than the pipe, through which the fluid continues to flow;
b) determining the size of a patch required to repair the damaged portion of the pipe;
c) preparing an FRP laminate patch of the required dimensions;
d) preparing the damaged portion of the pipe to receive the patch;
e) applying an epoxy resin to an outside surface of the patch;
f) coiling the patch around the conduit and moving the coiled patch to the damaged portion of the pipe such that the patch does not contact the inside surface of the pipe;
g) substantially uncoiling the patch by applying pressure thereto to force contact of the outside surface of the patch against the damaged portion of the pipe; and
h) removing the seals and the conduit from the pipe to allow fluid to flow through the patched portion of the pipe.

6. The method of claim 5 wherein steps b) and c) are reversed with step a).

7. The method of claim 5 wherein step h) is replaced with the steps:
h) waiting for the epoxy resin to cure;
i) releasing the pressure against the patch;
j) sealing at least an upstream edge of the patch against the inside surface of the pipe with a circular clamp; and
k) removing the seals and the conduit from the pipe to allow fluid to flow through the patched portion of the pipe.

8. The method of claim 5 wherein step b) is determining the size of a patch required to repair the damaged portion of the pipe such that both upstream and downstream edges of the patch extend past the damaged portion of the pipe by at least six inches, and such that overlapping edges of the patch overlap each other by at least two inches.

9. A method of repairing or reinforcing a length of pipe, comprising the steps of:
a) determining a suitable length and width of a patch;
b) preparing an FRP laminate patch of the required dimensions;
c) preparing the damaged portion of the pipe to receive the patch;
d) applying epoxy to an outside surface of the patch;
e) coiling the patch around a longitudinal axis to be co-aligned with the longitudinal axis of the pipe
f) aligning the longitudinal axis of the coiled patch with that of the pipe adjacent an open end of the pipe;
g) inserting the coiled patch into the open end of the pipe; and
h) releasing the coiled patch such that the outside surface of the patch presses against the inside surface of the pipe.

10. The method of claim 9 further including the step of i) inserting a bladder into the pipe and inflating the bladder to press the patch firmly against the inside surface of the pipe until the epoxy resin is cured.

11. The method of claim 9 wherein the pipe is a corrugated steel pipe, and wherein the FRP laminate patch comprises a layer of non-carbon fiber adjacent the outside surface of the patch, and a carbon-fiber layer between the non-carbon fiber layer and the inside surface of the patch, and further including the step:
j) filling the spaces between the corrugated steel pipe and the patch proximate each end of the patch with a filler material to seal the pipe between the corrugated steel and the patch.

12. The method of claim 9 wherein step a) is determining a suitable length and width of a patch such that overlapping edges of the patch overlap each other by at least two inches.

13. A method for repairing a damaged portion of a pipe, comprising the steps of:
a) determining the size of a plurality of patches required to repair the damaged portion of the pipe;
b) preparing the plurality of FRP laminate patches of the required dimensions;
c) preparing the damaged portion of the pipe to receive each patch;
d) applying an epoxy resin to an outside surface of a next patch to apply;
e) coiling and securing the next patch around a mandrel adapted to transport the patch to the damaged portion of the pipe through an open end thereof, such that the next patch does not contact the inside surface of the pipe;
f) inserting and rolling the mandrel and next patch through the pipe to the damaged portion thereof;
g) applying liquid pressure to a bladder inside the coiled next patch to force the unrolling of the next patch from the mandrel and pressurized contact of the outside surface of the next patch against the damaged portion of the pipe;
h) waiting for the epoxy resin to cure;
i) deflating the bladder and removing the mandrel from the pipe;
j) repeating from step d) as necessary to repair the damaged portion of the pipe; and
h) sealing at least an upstream edge of an upstream patch against the inside surface of the pipe with a circular clamp.

14. The method of claim 13 wherein steps b) and c) are reversed.

15. The method of claim 13 wherein step f) is inserting and rolling the mandrel and next patch through the pipe to the damaged portion thereof upstream from the previously-applied patch and overlapping the previously-applied patch by a predetermined distance;

16. A method for repairing a damaged portion of a pipe through which a fluid is flowing, comprising the steps of:
a) placing an upstream seal upstream of the damaged portion of the pipe and placing a downstream seal downstream of the damaged portion of the pipe, while providing a conduit therebetween having a smaller diameter than the pipe, through which the fluid continues to flow;
b) determining the size of a plurality of patches required to repair the damaged portion of the pipe;
c) preparing the plurality of FRP laminate patches of the required dimensions;
d) preparing the damaged portion of the pipe to receive each patch;
e) applying an epoxy resin to an outside surface of a next patch;
f) coiling the next patch around the conduit and moving the coiled next patch to the damaged portion of the pipe such that the next patch does not contact the inside surface of the pipe;
g) substantially uncoiling the next patch by applying pressure thereto to force contact of the outside surface of the next patch against the damaged portion of the pipe;
h) waiting for the epoxy resin to cure;
i) releasing the pressure against the next patch;
j) repeating from step e) as necessary to repair the damaged portion of the pipe;
k) sealing at least an upstream edge of an upstream outermost patch against the inside surface of the pipe with a circular clamp; and
l) removing the seals and the conduit from the pipe to allow fluid to flow through the patched portion of the pipe.

17. The method of claim 16 wherein steps b) and c) are reversed with step a).

18. The method of claim 15 wherein step f) is coiling the next patch around the conduit and moving the coiled next patch to the damaged portion of the pipe upstream from the previously-applied patch and overlapping the previously-applied patch by a predetermined distance, such that the next patch does not contact the inside surface of the pipe.
